(19) United States
(12) Patent Application Publication
(10) Pub. No.: US 2026/0304287 A1
(43) Pub. Date: Oct. 1, 2026

(54) METHODS AND APPARATUS FOR ESTABLISHING MESH NETWORKS ON MOBILE DEVICES FOR OFF-GRID COMMUNICATION

(71) Applicant: Silicon Laboratories Inc., Austin, TX (US)

(72) Inventors: Wael Guibene, McKinney, TX (US); Craig Babcock, II, Holland, MA (US)

(21) Appl. No.: 19/092,276

(22) Filed: Mar. 27, 2025

(51) Int. Cl. H04W 40/24; H04W 4/14; H04W 24/02; H04W 28/06; H04W 64/00; H04W 84/20

(52) U.S. Cl. CPC H04W 40/246; H04W 4/14; H04W 24/02; H04W 28/06; H04W 64/00; H04W 84/20

(57) ABSTRACT

In one embodiment, a method includes: creating, via a first wireless device, an Internet Protocol (IP)-based wireless mesh network, the first wireless device configured for communication via a cellular network and the IP-based wireless mesh network, the IP-based wireless mesh network to operate at a sub-gigahertz frequency; configuring the first wireless device as a leader for the IP-based wireless mesh network; identifying one or more other wireless devices in the IP-based wireless mesh network; and forming, based at least in part on identifying the one or more other wireless devices, a routing table and storing the routing table in the first wireless device, to enable communications to occur within the IP-based wireless mesh network.

### BACKGROUND

In off-grid environments, traditional communication methods that rely on cellular or centralized infrastructure are often unreliable or completely unavailable. A different wireless communication protocol, Internet Protocol (IPv6) over Low Power Wireless Personal Area Networks (6LoWPAN) allows for the creation of resilient, self-healing mesh networks that operate independently of centralized communication infrastructure. Mobile devices, however, typically lack the native capability to establish such networks.

### SUMMARY OF INVENTION

In one aspect, a method includes: creating, via a first wireless device, an Internet Protocol (IP)-based wireless mesh network, the first wireless device configured for communication via a cellular network and the IP-based wireless mesh network, the IP-based wireless mesh network to operate at a sub-gigahertz frequency; configuring the first wireless device as a leader for the IP-based wireless mesh network; identifying one or more other wireless devices in the IP-based wireless mesh network; and forming, based at least in part on identifying the one or more other wireless devices, a routing table and storing the routing table in the first wireless device, to enable communications to occur within the IP-based wireless mesh network.

In one implementation, the method further comprises creating the IP-based wireless mesh network in response to a user request. The method may also include updating the routing table based on one or more network communications within the IP-based wireless mesh network.

In an implementation, the method further comprises sending, from the first wireless device, to at least one of the one or more other wireless devices, at least one of text data or voice data via the IP-based wireless mesh network when the cellular network is unavailable. The method may also include determining that the cellular network is unavailable and receiving a user request for a fallback communication via the IP-based wireless mesh network. The voice data may be compressed voice data.

In an implementation, the method further includes sending, from the first wireless device, a broadcast communication to the one or more other wireless devices via the IP-based wireless mesh network, the broadcast communication comprising a short message service (SMS) message. The method may also include sending position information regarding the first wireless device to the one or more other wireless devices via the IP-based wireless mesh network. The position information may include global positioning satellite (GPS) data, where the first wireless device comprises a GPS device. The method may further include receiving, in the first wireless device, at least one message from a second wireless device and using the routing table to route the at least one message to a third wireless device via the IP-based wireless mesh network.

In another aspect, a method comprises: receiving, in the wireless device, text data or voice data from a user, the wireless device comprising at least one transceiver to communicate via a cellular network and via an IP-based wireless mesh network, the IP-based wireless mesh network to operate at a sub-gigahertz frequency; determining that the cellular network is unavailable and informing the user that the cellular network is unavailable; receiving a user request for a fallback operation; and in response to the user request, sending at least a portion of the text data or voice data to one or more wireless devices in the IP-based wireless mesh network.

In one implementation, the method further comprises sending the text data comprising a broadcast SMS message to a plurality of wireless devices in the IP-based wireless mesh network. The method may also include accessing a routing table stored in the wireless device and using information from the routing table to send the broadcast SMS message.

In an implementation, the method further comprises: receiving first position information regarding a location of a second wireless device in the IP-based wireless mesh network; updating, based on the first position information, stored position data for the second wireless device, the stored position data stored in a memory of the wireless device; and sending the updated stored position data to at least one other wireless device in the IP-based wireless mesh network to inform the at least one other wireless device regarding the location of the second wireless device. The method further may also include compressing the voice data before sending the at least the portion of the voice data to the one or more wireless devices in the IP-based wireless mesh network, the voice data comprising a voice message. The method may also include sending the at least portion of the text data or voice data to the one or more wireless devices in the IP-based wireless mesh network using: a media access control layer of the wireless device in accordance with an IEEE 802.15.4.e specification; and a physical layer of the wireless device in accordance with an IEEE 802.15.4.g specification.

In one example, a computer-readable storage medium including instructions is to perform the methods described above. In another example, a computer-readable storage medium including data is to be used by at least one machine to fabricate at least one integrated circuit to perform the methods described above. In yet another example, an apparatus comprises means for performing the methods described above.

In yet another aspect, a wireless device includes: a first transceiver to transmit and receive at least first radio frequency (RF) signals via a cellular network; a second transceiver to transmit and receive at least second RF signals via an off-grid mesh network, the off-grid mesh network to operate at a sub-gigahertz frequency; and at least one processor to process first baseband signals for communication via the first transceiver and second baseband signals for communication via the off-grid mesh network.

In one implementation, the wireless device is to communicate at least one of compressed text data or compressed voice data via the off-grid mesh network. The wireless device may include a non-volatile memory to store instructions, that when executed, cause the wireless device to communicate the at least one of compressed text data or compressed voice data via the off-grid mesh network after a communication via the cellular network fails. The wireless device may include a non-volatile memory to store instructions, that when executed, cause the wireless device to route at least one of text data or voice data received from a source wireless device in the off-grid mesh network to at least one destination wireless device in the off-grid mesh network using routing information of a routing table associated with the off-grid mesh network.

### BRIEF DESCRIPTION OF THE DRAWINGS

FIG. 1 is a block diagram of a wireless device in accordance and environment.

FIG. 2 is a flow diagram of a method in accordance with an embodiment.

FIG. 3 is a flow diagram of a method in accordance with another embodiment.

FIG. 4 is a flow diagram of a method in accordance with another embodiment.

FIG. 5 is a block diagram of a representative integrated circuit in accordance with an embodiment.

FIG. 6 is a high-level diagram of a network in accordance with an embodiment.

### DETAILED DESCRIPTION

In various embodiments, a wide range of wireless devices including mobile devices such as smartphones, smart watches and GPS trackers, among others, may be configured to establish and operate within an Internet Protocol (IP)-based wireless mesh network such as an IPv6 over Low Power Wireless Personal Area Network (6LoWPAN) using sub-GHz radio frequencies. Such network facilitates decentralized communication between devices, allowing for information including position sharing, text messaging, and voice data exchange to occur in environments devoid of cellular network coverage. In some implementations the wireless devices may communicate in such networks using, as examples, one or more of Thread and Wireless Smart Ubiquitous Network (Wi-SUN) protocol stacks. With embodiments, devices can participate in efficient decentralized communication, including sharing of GPS coordinates, text messages, and compressed voice data, in off-grid scenarios, which may occur outside of cellular networks.

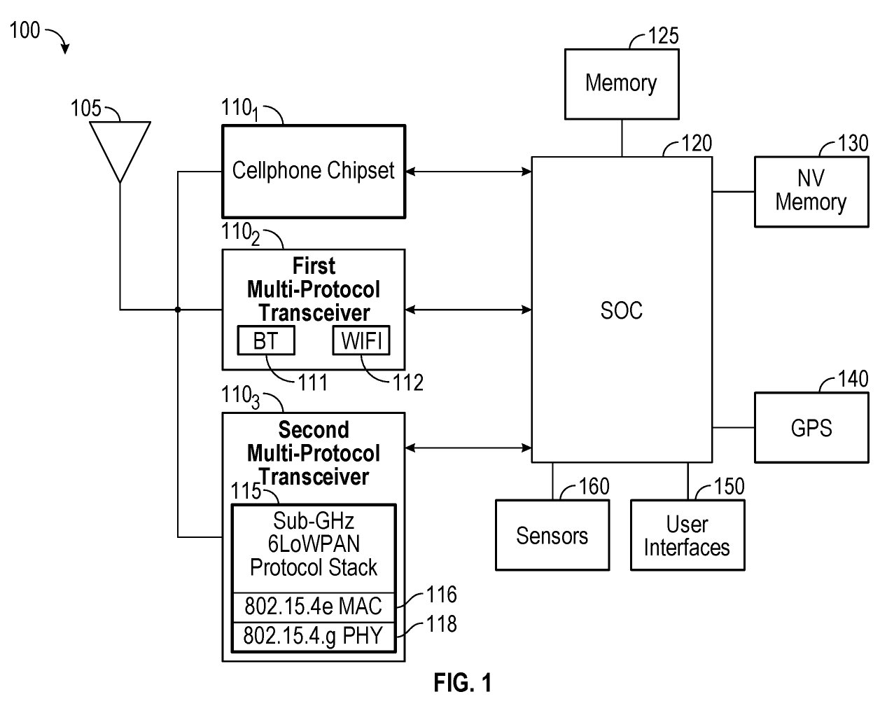

Referring now to FIG. 1, shown is a block diagram of a wireless device in accordance and environment. More specifically FIG. 1 illustrates at a high level an arrangement of a cellular phone such as a smartphone. Of course, in other implementations wireless device 100 may take other forms such as a personal digital assistant, smart watch or so forth. With embodiments, wireless device 100 provides for additional wireless communication in addition to cellular (or other centralized) network communications. Wireless device 100 may further communicate in wireless local area networks (WLANs) and or wireless personal area networks (WPANs) and/or wireless mesh networks. As described herein, device 110 also may communicate at sub-GHz frequencies in off-grid networks, such as a 6LoWPAN wireless mesh network.

As further shown, wireless device 100 may transmit and receive radio frequency (RF) signals via an antenna 105 that couples to a plurality of different transceivers 110₁₋₃. In the high level shown in FIG. 1, a cellular transceiver implemented as a cellphone chipset 110₁ provides for communication via a cellular network. A first multi-protocol transceiver 110₂ can be used for wireless communications of multiple wireless protocols. As shown in FIG. 1, such protocols may include Bluetooth communications via a Bluetooth protocol stack 111 and Wi-Fi communications via a Wi-Fi protocol stack 112, which may operate at frequencies of 2.4GHz and/or 5GHz.

As further shown in FIG. 1, a second multi-protocol transceiver 110₃includes a sub-GHz protocol stack 115, which may operate within designated sub-GHz frequency bands (e.g., 433 MHz, 868 MHz, 915 MHz or any proprietary band), and support various physical (PHY) and medium access control (MAC) layers for low-power, long-range communication. Transceiver 110₃may be configured for low-power operation, ensuring minimal battery drain while maintaining communication over extended distances. In implementations, transceiver 110₃may support various modulation schemes, including Orthogonal Frequency Division Multiplexing (OFDM), Gaussian/Frequency Shift Keying (G/FSK), and Offset Quadrature Phase-Shift Keying (O-PSK) depending on the selected PHY layer.

In an embodiment, protocol stack 115 may provide for IP-based communications via a 6LoWPAN communication protocol. As shown, protocol stack 115 implements a MAC layer 116 and a physical layer 118. Protocol stack 115 includes mechanisms for mesh routing, network formation, security (using AES-128 encryption), and low-power operation. In an embodiment, protocol stack 115 can be implemented within firmware of device 100 stored in a given non-volatile memory, enabling efficient IPv6 communication over low-power wireless networks. Layers 116, 118 can be in accordance with various IEEE specifications, and a range of PHY and MAC layers can be used to ensure flexibility and adaptability across different applications and regulatory environments, including proprietary low-power wide-area network (LPWAN) technologies. Understand while a single protocol stack 115 is shown, additional protocol stacks may be provided in other embodiments.

In certain embodiments, MAC layer 116 may be in accordance with an IEEE 802.15.4e specification, which may enhance an IEEE 802.15.4 MAC layer with features like IPv6 over Time-Slotted Channel Hopping (6TSCH), improving network robustness and coexistence with other wireless systems. In other embodiments, a proprietary MAC layer can be implemented, optimized for specific use cases, such as extended battery life or high-reliability communication in noisy environments.

In certain embodiments, PHY layer 118 may be in accordance with an IEEE 802.15.4g specification, which is optimized for low-data rate wireless communication in sub-GHz bands, supporting modulation schemes such as G/FSK, O-QPSK, and OFDM. In other cases, PHY layer 118 may be in accordance with an IEEE 802.15.4 specification such as used by Thread, to support Direct Sequence Spread Spectrum (DSSS) for robust and interference-resistant communication in sub-GHz bands. In other cases, a proprietary PHY layer may be used for long-range communication with low power consumption, suitable for wide-area mesh networks.

In embodiments, via protocol stack 115 communications of protocols including Thread and Wi-SUN may be optimized for reliability and power efficiency, making it suitable for battery-operated mobile devices. For example, a given Wi-SUN protocol may be used to provide robust, long-range communication, making it ideal for wide-area mesh networks in off-grid scenarios. Both Thread and Wi-SUN support IPv6, enabling seamless integration with existing and future IP-based communication systems.

Still with reference to FIG. 1, transceivers 110₁₋₃ couple to a system on chip (SoC) 120, which may be implemented as a host processor for wireless device 100, and may include one or more processing cores, memory, communication interfaces and so forth. As seen, additional components couple to SoC 120, including memory 125, which in an embodiment may be implemented as a random access memory. A non-volatile memory 130, e.g., a flash memory, also couples to SoC 120. Additional components further couple to SoC 120, including a GPS device 140 which may be used to maintain positioning information based on communications with one or more GPS satellites. User interfaces 150 may include a display, which may include a capacitive touch screen and microphone, among others, to enable user input. As further shown, a plurality of sensors 160 may couple to SoC 120. Sensors 160 may include temperature sensors, accelerometers and other position sensors, among other sensors. Although shown at this high level in the embodiment of FIG. 1, understand that many variations and alternatives are possible.

In one or more embodiments, wireless devices can be configured to perform a mesh network formation algorithm to dynamically discover, join, and leave a given mesh network. In such embodiments, the wireless network may have a decentralized network topology, where some or all devices (nodes) can act as a router, forwarding data between other nodes in the network.

With embodiments, multi-hop communications may occur, allowing data to traverse multiple nodes before reaching a destination node. In some implementations, routing may be performed using a metric-based approach, considering factors like signal strength, node battery level, and hop count to select an optimal path for data transmission. Implementations may also realize network resilience, as a device may automatically reroute a communication in case of node failure or network partitioning, ensuring continuous communication even in dynamic environments.

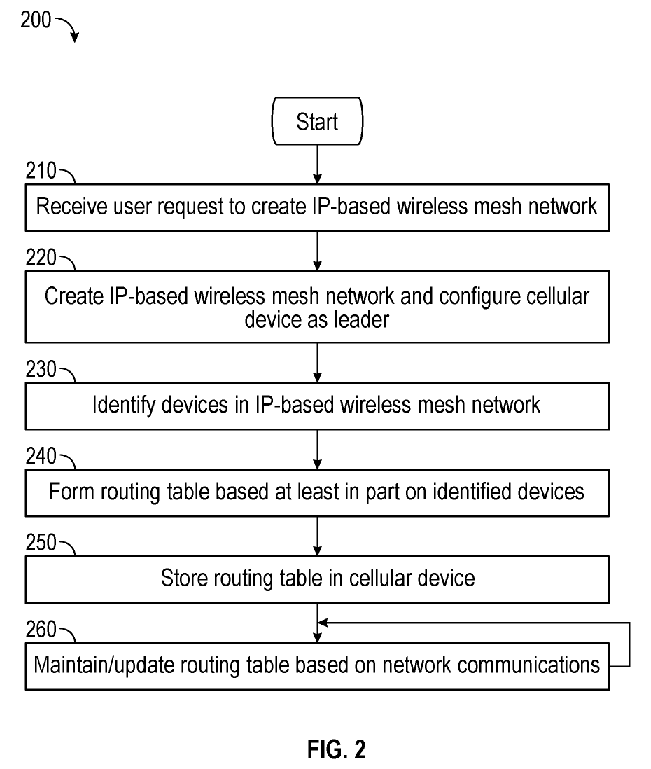

Referring now to FIG. 2, shown is a flow diagram of a method in accordance with an embodiment. As shown in FIG. 2, method 200 is a method for performing and maintaining an IP-based wireless mesh network. Although embodiments are not limited in this regard, in one implementation method 200 may be performed by a smartphone or other wireless device that includes hardware circuitry to perform method 200 alone, and/or in combination with firmware and/or software.

Method 200 begins by receiving a user request to create an IP-based wireless mesh network (block 210). As an example, a user may seek to create such network when the user expects to be in an environment in which cellular network service is spotty or wholly unavailable. For example, a user may seek to create a mesh network for a collection of users, e.g., family members, friends, work colleagues or so forth, each of whom have at least one wireless device. By creating such mesh network that can act as an off-grid network, these users can continue to have at least minimal communications in the absence of a cellular network, access point, or other centralized networking equipment.

Many different scenarios are possible. However, for purposes of consideration, one example is when a group of users expect to be outside of cell service, such as when embarking on a ski trip, hunting trip, hiking journey or so forth. Other examples may include first responders and other emergency personnel when in anticipation of entering into an environment which may lack cellular service such as due to wildfires or other adverse weather events. Still further examples may include a group of users entering into a festival, stadium or arena environment where due to the sheer number of users present, cellular network capacity may be constrained. These are just some examples of use cases enabled according to embodiments.

Still referring to FIG. 2, at block 220 the wireless device may create the mesh network and configure itself as a leader device of the network. Next, at block 230 the device may identify other devices in the wireless mesh network. To that end, the cellular device may perform a discovery process such as by sending ping messages, e.g., according to a given 6LoWPAN protocol, to identify other devices in a vicinity of the wireless mesh network. In some cases, security techniques may be used to ensure that only desired and verified devices and their users are allowed to be part of the mesh network. Note that using a sub-GHz 6LoWPAN protocol, the mesh network may be of a relatively long range, e.g., on the order of kilometers in some cases.

After identifying the relevant devices at block 240 a routing table may be formed. Such routing table may include information regarding the various devices, including identification of the devices (e.g., using at least a portion of an IPv6 address), a type of device, node identifier for the device and so forth. In some cases, the routing table may also identify nodes as being capable of routing (if unable to route, a node may be identified as an end device). Next at block 250 the routing table may be stored in the cellular device. At this point, the cellular device can communicate with one or more devices in the mesh network. Such communications may be unicast communications, multicast communications and/or broadcast communications.

As further shown in FIG. 2, the routing table may be maintained and/or updated based on network communications (block 260). That is, as devices move throughout the network and potentially leave the network, different routing information may be stored for a given devices and potentially when a device leaves, routing information associated with such device may be removed. Although not shown in FIG. 2, understand that in some implementations another device may provide at least portions of the routing table to other devices within the wireless mesh network. However, it is further possible for each such device configured within the mesh network to form and maintain its own routing tables. Although shown at this high level in the embodiment of FIG. 2, many variations and alternatives are possible. For example, a user can establish multiple off-grid wireless mesh networks, each with a different collection of other users/devices.

Once a network in accordance with an embodiment has been created, various communications may occur within the network. Although embodiments are not limited in this regard, such communications may include position sharing information, and text and/or voice communications. In some implementations, position sharing may be performed using GPS circuitry of the wireless devices. In this way, devices within the mesh network can exchange and synchronize position data derived from integrated GPS modules, utilizing efficient data encoding to minimize bandwidth usage. In such cases, devices may periodically broadcast their GPS coordinates to neighboring nodes using a compressed data format, minimizing the bandwidth required for position updates. In some embodiments, a synchronization protocol may be used to ensure that all devices within the network have up-to-date position information. This protocol is designed to be robust against packet loss and network delays, ensuring accurate and timely position sharing. Such position sharing may be used for applications such as search and rescue operations, team coordination in remote areas, and tracking of assets in off-grid environments. In these and other implementations, text and/or voice communication may occur using protocols for lightweight text messaging and voice communication, employing advanced compression techniques to optimize data transmission over the sub-GHz network.

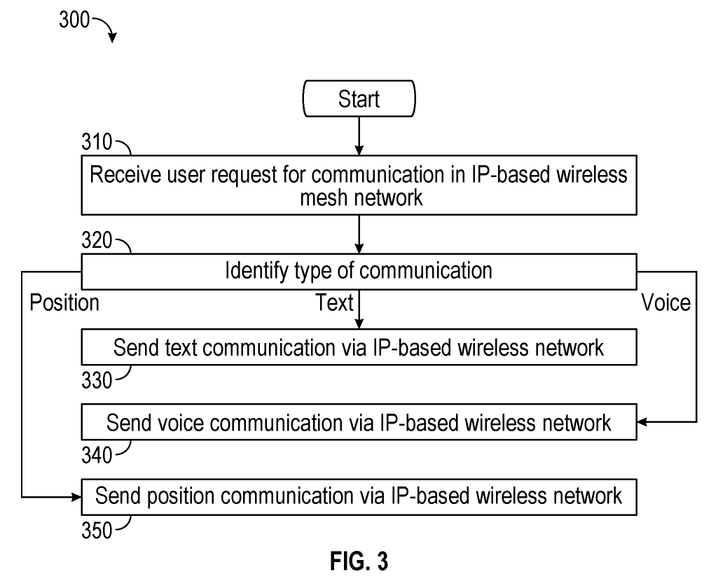

Referring to FIG. 3, shown is a flow diagram of a method in accordance with another embodiment. More specifically, method 300 is a method for performing various communications within a wireless mesh network. In an embodiment, method 300 may be performed by a smartphone or other wireless device that includes hardware circuitry to perform method 300 alone, and/or in combination with firmware and/or software.

As shown, method 300 begins by receiving a user request for a communication in the IP-based wireless mesh network (block 310). Based on this user request at block 320 the type of communication can be identified. Accordingly, the communication can be sent based on the identified type. For example, at block 330 a text communication can be sent in response to a user request for a text message. In an embodiment, text messages are transmitted using a lightweight, custom protocol that minimizes overhead and ensures reliable delivery even in low-bandwidth conditions. The protocol may include error correction mechanisms to handle packet loss and ensure message integrity.

Still with reference to FIG. 3, at block 340 a voice communication can be sent responsive to a user request for a voice message. In an embodiment, voice data is compressed using an efficient codec (e.g., Speex or Opus) to fit within limited bandwidth available in sub-GHz networks. In one or more embodiments, the voice communication protocol supports short voice clips, which are transmitted as discrete packets, allowing for clear and understandable communication even in challenging network conditions. Note that in embodiments, such voice communications may be one-way messages, rather than enabling of a live two-way communication. Finally, with further reference to FIG. 3, at block 350 a position communication can be sent responsive to a user request for a position message. Understand that any of these different types of data communications may be sent per the user request to a single other device as a unicast message, to multiple devices as a multicast message, or to all available devices within the mesh network as a broadcast message. Although shown at this high level in the embodiment of FIG. 3, many variations and alternatives are possible.

In FIG. 3, method 300 contemplates a situation in which a user makes a request for an off-grid communication using a wireless mesh network. In other cases, a user may initially seek to make a communication via a cellular or other centralized network but the communication fails, e.g., due to network unavailability. Thus, in other cases, a communication within the wireless mesh network may proceed responsive to a fallback request as a fallback operation when an initial transmission fails.

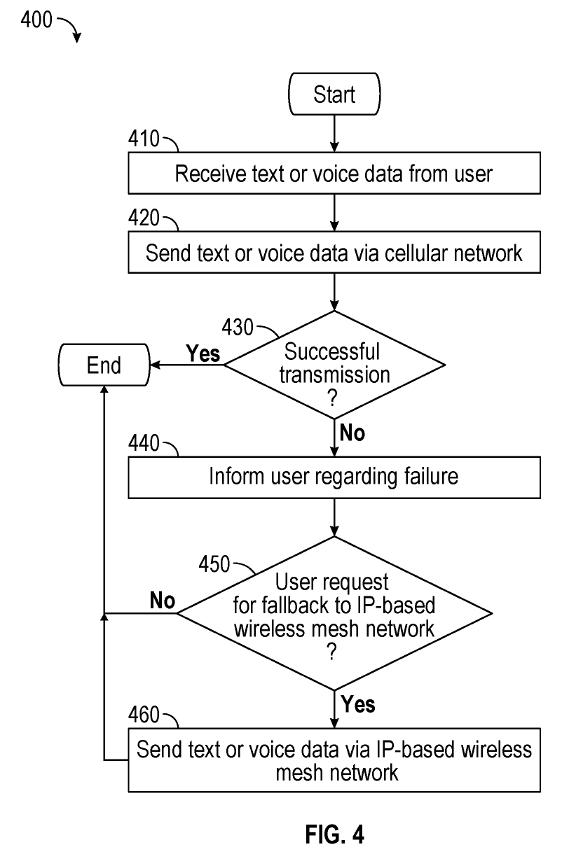

Referring now to FIG. 4, shown is a flow diagram of a method in accordance with another embodiment. More specifically, method 400 is a method for performing communications within a wireless mesh network, potentially including fallback communications as described herein. In one implementation method 400 may be performed by a smartphone or other wireless device that includes hardware circuitry to perform method 400 alone, and/or in combination with firmware and/or software.

Method 400 begins by receiving text or voice data from a user (block 410). Then using conventional smartphone functionality, the wireless device may send such data via the cellular network at block 420. It is then determined at diamond 430 if this transmission is successful. If so, no further operations occur in method 400, which concludes.

Otherwise, if it is determined that the transmission is not successful, at block 440, the device may inform the user regarding the failure, e.g., via a touch screen notification that the voice call or text did not succeed. Also, the device may prompt the user to determine whether the user desires a fallback for an abbreviated communication within the IP-based wireless mesh network. At diamond 450 it is determined whether a user request for this fallback operation is received. If so, control passes to block 460 where the text or voice data is sent via the IP-based wireless mesh network. Note that at least in the context of a voice call, given the low bandwidth of the mesh network, a compressed voice message, e.g., of a relatively short duration (such as less than one minute) can be sent. Similarly, a text message also may be sent in compressed form in some cases. As with other implementations discussed above, such text or voice-based communication may be sent as a unicast message to a single other device within the mesh network, to multiple devices as a multicast message, or as a broadcast message to all available devices. Although shown at this high level in the embodiment of FIG. 4, many variations and alternatives are possible.

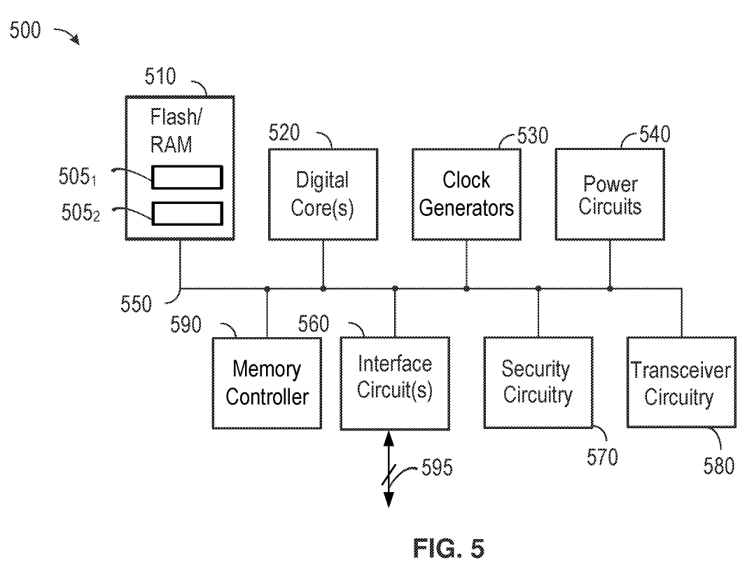

Referring now to FIG. 5, shown is a block diagram of a representative integrated circuit 500 that includes circuitry as described herein. In the embodiment shown in FIG. 5, integrated circuit 500 may be, e.g., a multi-mode wireless transceiver that may operate according to one or more wireless protocols (including at least sub-GHz wireless protocols) or other device that can be used in a variety of use cases. In one or more embodiments, the circuitry of integrated circuit 500 shown in FIG. 5 may be implemented on a single semiconductor die or implemented on separate dies for wireless communication, MCU compute, external flash and/or other IP blocks needed to perform various functionalities.

Integrated circuit 500 may be included in a range of devices, but for purposes of discussion, it may be incorporated into a smartphone. In the embodiment shown, integrated circuit 500 includes a memory system 510 which in an embodiment may include volatile storage, such as RAM and non-volatile memory such as a flash memory. The flash memory is a non-transitory storage medium that can store instructions and data. These instructions include a set of instructions that, when executed, cause one or more off-grid networks to be created and maintained, and for performing communications in such networks, as described herein.

As further shown in FIG. 5, memory system 510 may store first code 505₁ for creating and maintaining one or more 6LoWPAN networks as described herein. As further shown, memory subsystem 510 further includes second code 505₂ for communicating compressed voice, text, and/or position data in such networks. Integrated circuit 500 also may include a memory controller 590.

Memory system 510 couples via a bus 550 to one or more digital cores 520, which may include one or more cores and/or microcontrollers that act as processing units of the integrated circuit, and which may perform the operations as described herein. In turn, digital cores 520 may couple to clock generators 530 which may provide one or more phase locked loops or other clock generator circuitry to generate various clocks for use by circuitry of the IC.

As further illustrated, IC 500 further includes power circuitry 540. Additional circuitry may be present depending on particular implementation to provide various functionality and interaction with external devices. Such circuitry may include interface circuitry 560 which provides a digital communication interface with additional circuitry (such as another IC that can couple to IC 500 via a link 595). IC 500 also may include security circuitry 570 to perform wireless security techniques.

In addition, as shown in FIG. 5, transceiver circuitry 580 may be provided to enable transmission and reception of wireless signals, e.g., according to one or more of a local area or wide area wireless communication scheme, such as Matter, Thread, Zigbee, Bluetooth, IEEE 802.11, IEEE 802.15.4, cellular communication or so forth. Understand while shown with this high-level view, many variations and alternatives are possible.

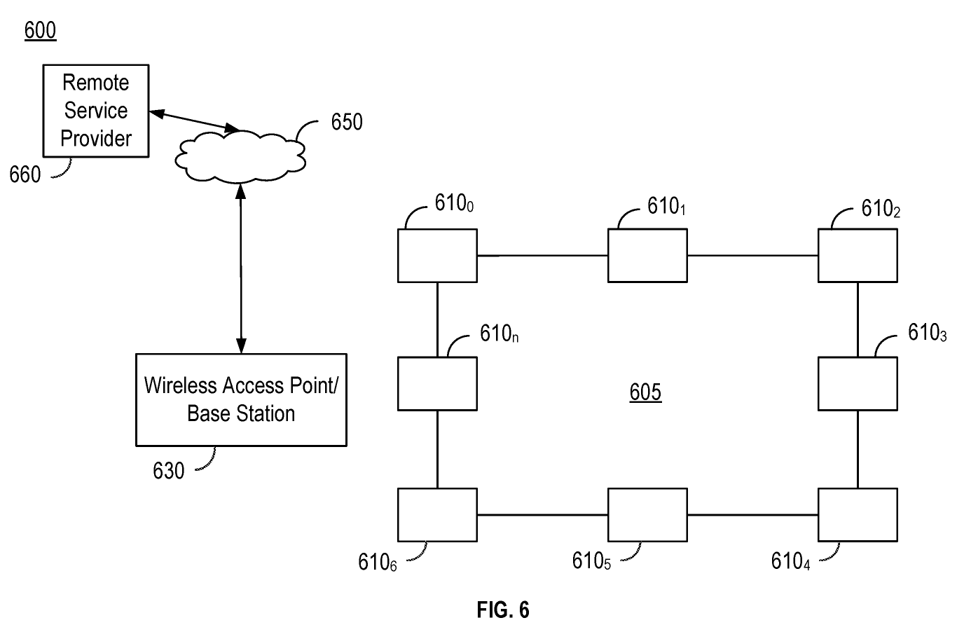

ICs such as described herein may be implemented in a variety of different devices as described above. Referring now to FIG. 6, shown is a high-level diagram of a network in accordance with an embodiment. As shown in FIG. 6, a network 600 includes a variety of devices, including wireless devices that may communicate using cellular and off-grid networks as described herein.

In the embodiment of FIG. 6, a wireless mesh network 605 is present, e.g., aa 6LoWPAN network established across a relatively wide range, and which may include multiple wireless devices 610₀₋ₙ. As shown, wireless devices 610, which may be smartphones or other wireless devices, couple to an access point/base station 630 (when available) that in turn communicates with a remote service provider 660 via a wide area network 650, e.g., a cellular network and/or the Internet. When such centralized networks are unavailable, devices 610 may communicate at sub-GHz frequencies within mesh network 605 as described herein. Understand while shown at this high level in the embodiment of FIG. 6, many variations and alternatives are possible.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
creating, via a first wireless device, an Internet Protocol (IP)-based wireless mesh network, the first wireless device configured for communication via a cellular network and the IP-based wireless mesh network, the IP-based wireless mesh network to operate at a sub-gigahertz frequency;
configuring the first wireless device as a leader for the IP-based wireless mesh network;
identifying one or more other wireless devices in the IP-based wireless mesh network; and
forming, based at least in part on identifying the one or more other wireless devices, a routing table and storing the routing table in the first wireless device, to enable communications to occur within the IP-based wireless mesh network.

2. The method of claim 1, further comprising creating the IP-based wireless mesh network in response to a user request.

3. The method of claim 1, further comprising updating the routing table based on one or more network communications within the IP-based wireless mesh network.

4. The method of claim 1, further comprising sending, from the first wireless device, to at least one of the one or more other wireless devices, at least one of text data or voice data via the IP-based wireless mesh network when the cellular network is unavailable.

5. The method of claim 4, further comprising determining that the cellular network is unavailable and receiving a user request for a fallback communication via the IP-based wireless mesh network.

6. The method of claim 4, further comprising sending the voice data comprising compressed voice data.

7. The method of claim 1, further comprising sending, from the first wireless device, a broadcast communication to the one or more other wireless devices via the IP-based wireless mesh network, the broadcast communication comprising a short message service (SMS) message.

8. The method of claim 1, further comprising sending position information regarding the first wireless device to the one or more other wireless devices via the IP-based wireless mesh network.

9. The method of claim 8, further comprising sending the position information comprising global positioning satellite (GPS) data, the first wireless device comprising a GPS device.

10. The method of claim 1, further comprising receiving, in the first wireless device, at least one message from a second wireless device and using the routing table to route the at least one message to a third wireless device via the IP-based wireless mesh network.

11. A computer-readable storage medium comprising instructions that when executed by at least one processor of a wireless device cause the wireless device to perform a method comprising:
receiving, in the wireless device, text data or voice data from a user, the wireless device comprising at least one transceiver to communicate via a cellular network and via an Internet Protocol (IP)-based wireless mesh network, the IP-based wireless mesh network to operate at a sub-gigahertz frequency;
determining that the cellular network is unavailable and informing the user that the cellular network is unavailable;
receiving a user request for a fallback operation; and
in response to the user request, sending at least a portion of the text data or voice data to one or more wireless devices in the IP-based wireless mesh network.

12. The computer-readable storage medium of claim 11, wherein the method further comprises sending the text data comprising a broadcast short message service (SMS) message to a plurality of wireless devices in the IP-based wireless mesh network.

13. The computer-readable storage medium of claim 12, wherein the method further comprises accessing a routing table stored in the wireless device and using information from the routing table to send the broadcast SMS message.

14. The computer-readable storage medium of claim 11, wherein the method further comprises:
receiving first position information regarding a location of a second wireless device in the IP-based wireless mesh network;
updating, based on the first position information, stored position data for the second wireless device, the stored position data stored in a memory of the wireless device; and
sending the updated stored position data to at least one other wireless device in the IP-based wireless mesh network to inform the at least one other wireless device regarding the location of the second wireless device.

15. The computer-readable storage medium of claim 11, wherein the method further comprises compressing the voice data before sending the at least the portion of the voice data to the one or more wireless devices in the IP-based wireless mesh network, the voice data comprising a voice message.

16. The computer-readable storage medium of claim 11, wherein the method further comprises sending the at least portion of the text data or voice data to the one or more wireless devices in the IP-based wireless mesh network using:
a media access control layer of the wireless device in accordance with an IEEE 802.15.4.e specification; and
a physical layer of the wireless device in accordance with an IEEE 802.15.4.g specification.

17. A wireless device comprising:
a first transceiver to transmit and receive at least first radio frequency (RF) signals via a cellular network;
a second transceiver to transmit and receive at least second RF signals
via an off-grid mesh network, the off-grid mesh network to operate at a sub-gigahertz frequency; and
at least one processor to process first baseband signals for communication via the first transceiver and second baseband signals for communication via the off-grid mesh network.

18. The wireless device of claim 17, wherein the wireless device is to communicate at least one of compressed text data or compressed voice data via the off-grid mesh network.

19. The wireless device of claim 18, wherein the wireless device comprises a non-volatile memory to store instructions, that when executed, cause the wireless device to communicate the at least one of compressed text data or compressed voice data via the off-grid mesh network after a communication via the cellular network fails.

20. The wireless device of claim 17, wherein the wireless device comprises a non-volatile memory to store instructions, that when executed, cause the wireless device to route at least one of text data or voice data received from a source wireless device in the off-grid mesh network to at least one destination wireless device in the off-grid mesh network using routing information of a routing table associated with the off-grid mesh network.
